(19) United States
(12) Patent Application Publication
(10) Pub. No.: US 2019/0259257 A1
(43) Pub. Date: Aug. 22, 2019

(54) SECURITY SENSOR DEVICE

(71) Applicant: OPTEX CO., LTD., Shiga (JP)

(72) Inventors: Chihiro MORITA, Otsu-shi (JP); Hiroyuki IKEDA, Otsu-shi (JP)

(73) Assignee: OPTEX CO., LTD., Shiga (JP)

(21) Appl. No.: 16/214,988

(22) Filed: Dec. 10, 2018

(30) Foreign Application Priority Data
Feb. 16, 2018 (JP) 2018-025911

(51) Int. Cl. G08B 13/19

(52) U.S. Cl. CPC G08B 13/19; G08B 13/181

(57) ABSTRACT

A cover unit covering a front face of a base unit having detection elements for detecting detection rays has a plurality of optical members present so as to be aligned about a predetermined axis, and the base unit has detection elements disposed at light-concentrated positions onto which the detection rays from the plurality of optical members are concentrated. The base unit further has shielding curved plates housed in the cover unit, and the shielding curved plates are set so as to be rotatable about the predetermined axis, and are locked at predetermined positions in a rotation direction to block the detection rays coming to the detection elements.

### CROSS REFERENCE TO THE RELATED APPLICATION

This application is based on and claims Convention priority to Japanese patent application No. 2018-025911, filed Feb. 16, 2018, the entire disclosure of which is herein incorporated by reference as a part of this application.

### BACKGROUND OF THE INVENTION

### Field of the Invention

The present invention relates to a security sensor device having detector for detecting detection rays.

### Description of Related Art

Hitherto, a security sensor device including an active type infrared security sensor (AIR (Active Infra-Red) sensor) which has one or more pairs of a projector and a receiver for detection rays that are electromagnetic waves such as infrared rays and which detects an object by using infrared rays that have been projected and subsequently reflected on the object, or a passive type infrared security sensor (PIR (Passive Infra-Red) sensor) which detects far-infrared rays emitted from a creature or a human body that is a detection object, has been known.

The following two conventional arts (1) and (2) have been known as a security sensor device including a PIR sensor.

(1) A passive type infrared ray detection device including: two sensor units each having a vertically two-stage configuration and having a far-infrared ray detection element with a field of view (FOV) of about 90 degrees in the horizontal direction; and a semi-cylindrical Fresnel lens including a plurality of lens pieces. The respective sensor units are configured to be individually rotatable by 90 degrees in the right-left direction and a control unit for receiving two signals from the sensor units are further provided. In the passive type infrared ray detection device, the control unit has a detection mode switching function to switch between: an AND operation in which a detection signal is outputted when both input signals are received; and an OR operation in which a detection signal is outputted when any one of the input signals is received. Each sensor unit has a vertically two-stage configuration, one of the sensor units has a function to adjust a watch distance and further includes a light-shielding sheet for limiting an infrared ray energy concentration region (area), and the light-shielding sheet is attachable in and detachable from a space behind the Fresnel lens in the device (JP Laid-open Patent Publication No. 2005-201754).

(2) A far-infrared ray human body detection device including one semi-circular cylindrical Fresnel lens and two far-infrared ray detection elements (FOV: 90 degrees) housed in different packages in order to expand the detection region of one device, for example, in order to set a range of 180 degrees as a detection region. In the far-infrared ray human body detection device, the Fresnel lens is configured to concentrate far-infrared ray energy therethrough onto the two far-infrared ray detection elements, and is specifically formed of a plurality of divisional lens pieces in order to concentrate far-infrared ray energy from a plurality of optical axis directions onto the two far-infrared ray detection elements. The two far-infrared ray detection elements are arranged (fixed) so as to be tilted by 90 degrees relative to each other, so that far-infrared ray energy from directions of 180 degrees in total is concentrated onto the far-infrared ray detection elements (JP Laid-open Utility Model Publication No. H6-81091).

In the conventional art (1) described in JP Laid-open Patent Publication No. 2005-201754, a detection direction can be easily set owing to the rotation structure of each sensor unit, but there is a possibility of damage to a joint of a board and an electric wire from the sensor unit, and there is also a possibility that the rotation structure causes a complicated structure, resulting in an increase in number of components and an increase in cost. In addition, in the conventional art (1), the lens pieces are arranged so as to be distributed equally in the horizontal direction in order to maintain the sensitivity in an area (detection sensitivity), obtained by lens pieces of the Fresnel lens that are located in a direction straight facing each far-infrared ray detection element (near the center of the FOV) at each time, at the same level regardless of the direction of rotation of the sensor unit. In this case, as characteristics of the infrared ray detection elements, the sensitivity at each end of the FOV is decreased as compared to that near the center of the FOV. Thus, when the case of a product is assumed, the sensitivity in each of areas located horizontally cannot be adjusted to be uniform. For example, the widths in the horizontal direction of the lens pieces located at the ends of the FOV cannot be made larger than those of the lens pieces located at the center of FOV. In the conventional art (2) described in JP Laid-open Utility Model Publication No. H6-81091, since the two infrared ray detection elements are fixed, no wire damage or no structure complication occurs, and thus it is possible to arrange lens pieces that make the sensitivity uniform in the horizontal direction.

In the conventional art (2) described in JP Laid-open Utility Model Publication No. H6-81091, in the case of limiting the detection direction as a countermeasure against an erroneous operation, in the case of desiring not to perform detection in a certain range of the detection range, or in the case of desiring not to perform detection in local areas, masking has to be performed using a light-shielding sheet, which is the same as in the case of JP Laid-open Patent Publication No. 2005-201754. In addition, work of attaching such a light-shielding sheet takes time and effort, and the light-shielding sheet is also attached at the Fresnel lens side and thus can be viewed through the Fresnel lens from the external side of the Fresnel lens, so that the masking region is recognized by a stranger or the appearance is impaired in terms of design. Moreover, since the light-shielding sheet is attached at the Fresnel lens side, the attaching work is work of attaching the light-shielding sheet while viewing the Fresnel lens from the inner side. Thus, when the front of the infrared ray human body detection device is viewed from the external side, there is a possibility that the position in the right-left direction at which the light-shielding sheet is attached is mistakenly opposite to the position in the right-left direction where masking is actually performed, and thus the attaching work may take further time and effort.

Therefore, an object of the present invention is to provide a security sensor device that makes masking work of attaching a light-shielding sheet at a Fresnel lens side, etc., unnecessary and can flexibly handle setting of a detection direction through simple work, in order to eliminate the above drawbacks of the conventional art.

### SUMMARY OF THE INVENTION

As a result of conducting various studies, the present inventor has found that the above object is achieved by the following invention.

A security sensor device according to the present invention is a security sensor device including: a base unit having a detection element for detecting detection rays; and a cover unit covering a front face of the base unit, wherein

the cover unit has a plurality of optical members present so as to be aligned about a predetermined axis,

the base unit has the detection element disposed at a light-concentrated position onto which the detection rays from the plurality of optical members are concentrated,

the base unit further has a shielding curved plate housed in the cover unit, and

the shielding curved plate is set so as to be rotatable about the predetermined axis, and is locked at a predetermined position in a rotation direction to block the detection rays coming to the detection element.

Due to this configuration, it is not necessary to perform masking using a light-shielding sheet as in the conventional art, and it is also possible to flexibly handle setting of the detection direction by performing simple work of rotating the shielding curved plate and locking the shielding curved plate at the predetermined position at the base unit side. In the configuration having such shielding curved plate, in the case where the detection element has a fixing structure for not making a rotation motion about the predetermined axis relative to the base unit, the effect of being able to flexibly handle setting of the detection direction can be further exerted, for example, as compared to the conventional art (2).

In the above configuration, two plates rotatable independently of each other are preferably present as the shielding curved plate. Accordingly, for example, by arranging the two shielding curved plates at the left side and the right side, respectively, of the security sensor device, the directions in which detection of the detection rays at the left side and the right side is blocked can be independently set, and also, for example, by decreasing the gap between the two shielding curved plates, the range where detection is performed can be optionally reduced, and the direction of the reduced range can be a specific direction or any selected direction.

In the above configuration, the security sensor device may further include a long-length light-shielding member provided so as to be aligned about the predetermined axis and parallel to the predetermined axis and blocking the detection rays coming to the detection element. By using the light-shielding member, the detection direction in which the detection rays are blocked can be locally set in addition to the shielding curved plate. Moreover, since the light-shielding member is attached at the base unit side at which the detection element is present and not at the cover unit side at which the plurality of optical members are present, attaching work that takes time and effort as with work performed when attaching a light-shielding sheet for masking while viewing the plurality of optical members from the inner side as in the conventional art, is not required.

In the above configuration, preferably, the security sensor device has two or more far-infrared ray detection elements each having a field of view of about 90 degrees, and the two or more far-infrared ray detection elements are arranged such that a total field of view thereof is about 180 degrees. Due to the configuration of the infrared ray detection element using the two far-infrared ray detection elements each having a field of view of 90 degrees such that the field of view is 180 degrees, avoidance of the above-described wire damage or structure complication due to rotation (structure), etc., becomes possible as compared to a configuration in which adjustment is performed such that the total field of view is 180 degrees by rotating infrared ray detection elements each having a field of view of 90 degrees. In addition, a security sensor device in which the far-infrared ray detection elements are used as PIR sensors can be provided.

In the above configuration, the shielding curved plate may be transparent in a view in an incoming direction of the detection rays. If the shielding curved plate is not transparent, there is a possibility that the shielding curved plate is viewed from the outside of the security sensor device through the plurality of optical members and thus the shielding region is recognized. In this configuration, since the shielding curved plate is transparent, such a possibility can be reduced.

In the above configuration, the light-shielding member may be transparent in a view in an incoming direction of the detection rays. If the light-shielding member is not transparent, there is a possibility that the light-shielding member is viewed from the outside of the security sensor device through the plurality of optical members and thus the shielding region is recognized. In this configuration, since the light-shielding member is transparent, such a possibility can be reduced.

Any combination of at least two constructions, disclosed in the appended claims and/or the specification and/or the accompanying drawings should be construed as included within the scope of the present invention. In particular, any combination of two or more of the appended claims should be equally construed as included within the scope of the present invention.

### BRIEF DESCRIPTION OF THE DRAWINGS

In any event, the present invention will become more clearly understood from the following description of preferred embodiments thereof, when taken in conjunction with the accompanying drawings. However, the embodiments and the drawings are given only for the purpose of illustration and explanation, and are not to be taken as limiting the scope of the present invention in any way whatsoever, which scope is to be determined by the appended claims. In the accompanying drawings, like reference numerals are used to denote like parts throughout the several views, and:

FIG. 1 is an exploded perspective view of a security sensor device according to a first embodiment of the present invention;

FIG. 2A is a front view of a detection lens inside a cover unit of the security sensor device;

FIG. 2B is a cross-sectional top view taken along the line IIB-IIB in

FIG. 2A;

FIG. 3 is an exploded plan view of the security sensor device;

FIG. 4 is a perspective top view of a base unit of the security sensor device;

FIG. 5A is a conceptual cross-sectional top view showing an example of arrangement of shielding curved plates of the security sensor device;

FIG. 5B is a conceptual cross-sectional top view showing an example of arrangement of the shielding curved plates of the security sensor device;

FIG. 5C is a conceptual cross-sectional top view showing an example of arrangement of the shielding curved plates of the security sensor device;

FIG. 5D is a conceptual cross-sectional top view showing an example of arrangement of the shielding curved plates of the security sensor device;

FIG. 6 is an exploded perspective view showing a main part of the security sensor device;

FIG. 7 is an exploded perspective view of a security sensor device according to a second embodiment of the present invention;

FIG. 8 is a perspective view of a light-shielding member of the security sensor device; and

FIG. 9 is a block diagram of an electrical system used in the security sensor device of each of the embodiments.

### DESCRIPTION OF EMBODIMENTS

Hereinafter, embodiments of the present invention will be described with reference to the drawings. In each drawing, like reference numeral denotes like parts, and the description thereof is omitted as appropriate unless change or the like is described otherwise.

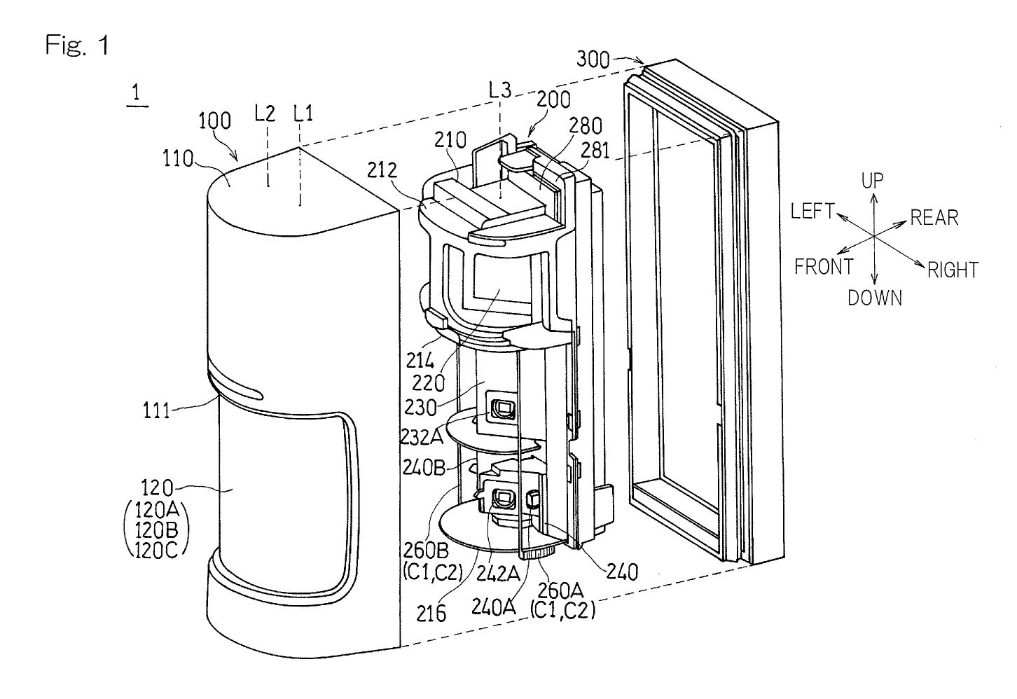

FIG. 1 shows an exploded perspective view of a security sensor device 1 according to a first embodiment of the present invention. In the present embodiment, far-infrared rays are used as detection rays, and the security sensor device 1 has, as detection ray sensors, far-infrared ray detection elements (hereinafter, also referred to merely as infrared ray detection elements) 232A, 232B, 242A, and 242B that are PIR sensors, and is used for detection of human bodies indoor or outdoor, that is, detection of intruders, etc. The security sensor device 1 includes at least a cover unit 100 and a base unit 200 and also includes a mount 300 to which the cover unit 100 and the base unit 200 are attached. The mount 300 can be mounted to a pillar, a wall, or the like by means of mounting tools such as screws. The cover unit 100 covers the front face of the base unit 200, that is, the face thereof facing a detection object.

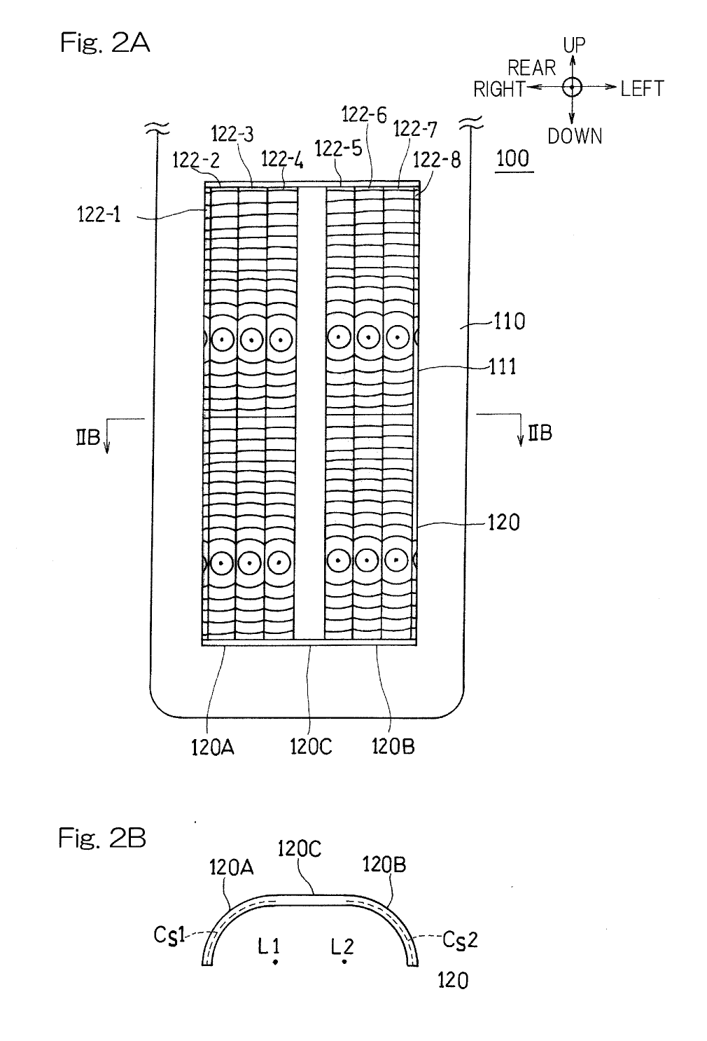

As shown in FIG. 2A, the cover unit 100 has a detection lens 120 that is a detection optical system. An opening 111 is provided in a lower half portion of the cover unit 100 and closed by the detection lens 120. The detection lens 120 is an optical member having a high infrared ray transmittance as shown in the front view of the detection lens 120 at the inner side of the cover unit in FIG. 2A. The detection lens 120 is a multi-segment lens including a plurality of optical members 122-1 to 122-8 that are present so as to be aligned on two optical-system-side virtual cylindrical surfaces Cs1 and Cs2 (corresponding to axes L1 and L2, respectively) present around a later-described predetermined axis L3 in the present embodiment as shown in FIG. 2B. Each of the optical members 122-1 to 122-8 is a long-length Fresnel lens piece (hereinafter, also referred to merely as lens piece) parallel to the axis L1 or L2 of the optical-system-side virtual cylindrical surface Cs1 or Cs2. As shown in FIG. 1, the axis L1, the axis L2, and the predetermined axis L3 are parallel to each other, and the axes L1 and L2 are present near the predetermined axis L3. These axes L1, L2, and L3 extend, for example, substantially in the vertical direction.

Specifically, in the present embodiment, the multiple lens pieces 122-1 to 122-4 present in the left half of FIG. 2A form a Fresnel lens 120A that is an optical member group including a plurality of optical members, and the multiple lens pieces 122-5 to 122-8 present in the right half of FIG. 2A form a Fresnel lens 120B. Thus, the two Fresnel lenses 120A and 120B are curved surfaces that coincide with the corresponding optical-system-side virtual cylindrical surfaces Cs1 and Cs2, respectively. For example, each of the Fresnel lenses 120A and 120B is a curved surface having a shape that is an arc centered at the corresponding axis L1 or L2 and having a central angle of 90 degrees, in a plane orthogonal to the axes L1 and L2 of the optical-system-side virtual cylindrical surface Cs1 and Cs2, for example, in a horizontal plane. In FIG. 2A, the detection lens 120 includes eight lens pieces in total, and each of the Fresnel lenses 120A and 120B includes four lens pieces, but the numbers of lens pieces are not limited thereto.

As shown in FIG. 2B, the detection lens 120 includes the two Fresnel lenses 120A and 120B and a connection portion 120C present therebetween. The connection portion 120C is a substantially rectangular flat surface or a slightly curved surface. The detection lens 120 is formed such that the Fresnel lenses 120A and 120B and the connection portion 120C connecting these Fresnel lenses 120A and 120B are integrated with each other, and the Fresnel lenses 120A and 120B and the connection portion 120C form a uniform or continuous surface in which the boundaries among the Fresnel lenses 120A and 120B and the connection portion 120C are not recognized. The material of the detection lens 120 is a material having good optical efficiency for the wavelength range of electromagnetic waves used as detection rays (far-infrared rays in the present embodiment), and is, for example, a polyethylene resin.

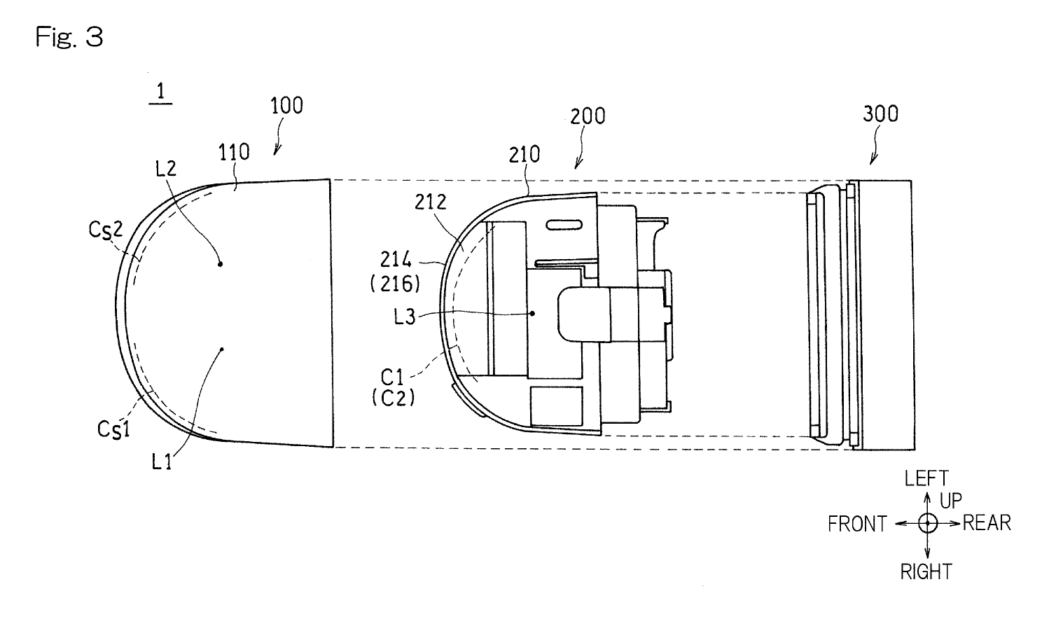

In the security sensor device 1 of the present embodiment, the infrared ray detection elements 232A, 232B, 242A, and 242B are fixed such that the infrared ray detection elements 232A, 232B, 242A, and 242B do not rotate about the axes L1 and L2 or the rotation axis L3 (described later) in FIG. 3 that is a predetermined axis. Then, the relative position relationship in the horizontal direction between the infrared ray detection elements 232A, 232B, 242A, and 242B and the detection lens 120, which is a multi-segment lens, is fixed. Thus, the sensitivity in a detection area (detection region) is made uniform by arranging, in constantly corresponding relation to an angular direction in which the sensitivity of the infrared ray detection elements is decreased, lens pieces that improve this decreased sensitivity of the infrared ray detection elements, that is, by adjusting the width (the length in a direction orthogonal to the axis L1 or L2) or the area of each lens piece in accordance with a sensitivity distribution in the FOV of each element. For example, the sensitivity is made uniform by decreasing the widths of lens at and near the center of the FOV which is a later-described detection center and at which the detection element sensitivity is increased, and by increasing the widths of lens at the ends of the FOV at which the sensitivity is decreased.

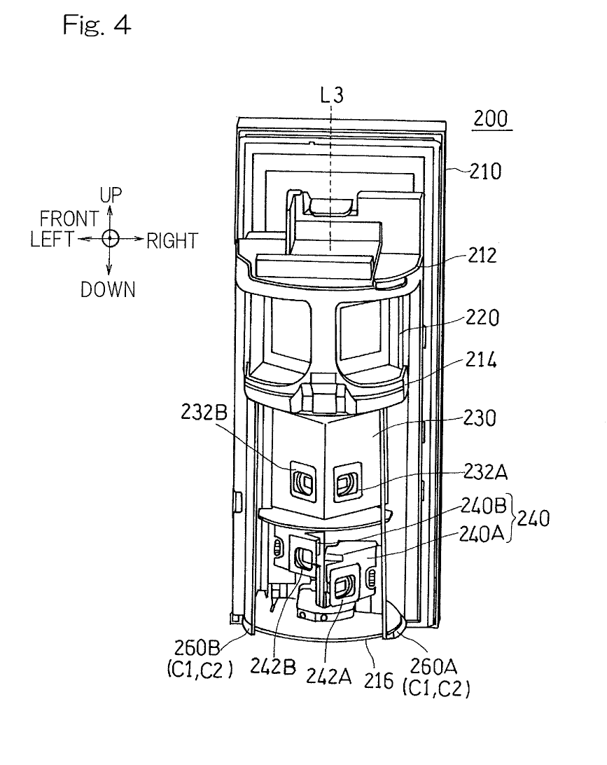

The base unit 200 shown in FIG. 1 has the infrared ray detection elements 232A, 232B, 242A, and 242B and further has a signal processing unit 280 and a main body 210 to which these components are attached. The infrared ray detection elements 232A, 232B, 242A, and 242B are disposed at light-concentrated positions onto which infrared rays from the respective lens pieces in Fresnel lenses 120A and 120B are concentrated. The signal processing unit 280 is housed in a recess 281 in a rear upper portion of the main body 210 within the base unit 200, and processes output signals from the infrared ray detection elements 232A, 232B, 242A, and 242B and outputs a detection signal (FIG. 9). Specifically, as shown in FIG. 4, the main body 210 of the present embodiment includes: an additional sensor installation portion 220 in which, for example, a microwave sensor can be additionally installed; a first detection element portion 230; and a second detection element portion 240. The additional sensor installation portion 220, the first detection element portion 230, and the second detection element portion 240 are separated by an upper flange portion 212 having a semi-disc-shaped portion that is substantially inscribed in a later-described first sensor-side virtual cylindrical surface C1, a flange portion 214 near the center, a flange portion 216 present at the lowermost side, etc.

As for the first detection element portion 230, the infrared ray detection elements 232A and 232B each having a FOV (field of view) of 90 degrees are housed in a single case having a substantially triangular column shape. The infrared ray detection elements 232A and 232B are arranged such that detection center directions thereof form 90 degrees. Specifically, the infrared ray detection elements 232A and 232B are arranged on two sides excluding the hypotenuse of a right-angled isosceles triangle on a cross-section orthogonal to the later-described rotation axis L3, which is parallel to the axes L1 and L2, such that the infrared ray detection elements 232A and 232B face toward the external side. Here, this detection center directions are each a direction straight facing the infrared ray detection element, a direction of substantially the center of the FOV of the infrared ray detection element, or a direction in which the detection sensitivity is at its maximum. Accordingly, the total FOV of the two infrared ray detection elements 232A and 232B is 180 degrees. The first detection element portion 230 and the infrared ray detection elements 232A and 232B are fixed such that the detection element portion 230 and the infrared ray detection elements 232A and 232B do not rotate relative to the base unit 200. In addition, in the present embodiment, the infrared ray detection elements 232A and 232B are also fixed such that the positions thereof do not change relative to the base unit 200, but these positions may change, for example, in the up-down direction.

The second detection element portion 240 includes two infrared ray detection units 240A and 240B each having a substantially triangular column shape. The first infrared ray detection unit 240A has the infrared ray detection element 242A having a FOV of 90 degrees, and the second infrared ray detection unit 240B has the infrared ray detection element 242B having a FOV of 90 degrees. The infrared ray detection elements 242A and 242B are arranged such that the detection center directions thereof form 90 degrees. Specifically, the infrared ray detection elements 242A and 242B are arranged on two sides excluding the hypotenuse of a right-angled isosceles triangle on a cross-section orthogonal to the rotation axis L3, facing toward the external side, when the entire second detection element portion 240 is viewed. Accordingly, the total FOV of the two infrared ray detection elements 242A and 242B is 180 degrees. Due to the above configuration, the detection center directions of the infrared ray detection element 232A and the infrared ray detection element 242A are substantially the same, and the detection center directions of the infrared ray detection element 232B and the infrared ray detection element 242B are substantially the same. In the present embodiment, the infrared ray detection elements 232A, 232B, 242A, and 242B are PIR sensors.

Both infrared ray detection units 240A and 240B may be movable independently to each other such that the positions thereof change relative to the base unit 200 in the rotation axis L3 direction. For example, when the lengths in the axis direction of the infrared ray detection units 240A and 240B are denoted by W, the movement distance of each of the infrared ray detection units 240A and 240B may be substantially the length W. FIG. 4 shows a state where the positions of the infrared ray detection units 240A and 240B are displaced relative to each other along the axis direction by a length that is about 0.5 W. When the infrared ray detection units 240A and 240B are movable in the axis direction, the detection distances of the infrared ray detection units 240A and 240B are changeable, and thus the detection distance (also referred to as watch distance) of the security sensor device 1 can be adjusted. In the present embodiment, the infrared ray detection elements 242A and 242B are independently movable, respectively, such that the positions thereof change relative to the base unit 200 in the axis direction as described above, but have a fixing structure for not making a rotation motion like the infrared ray detection elements 232A and 232B.

The base unit 200 is attached to the mount 300 so as to be housed in the cover unit 100, and has a first shielding curved plate 260A and a second shielding curved plate 260B that block infrared rays coming to the infrared ray detection elements 232A, 232B, 242A, and 242B. In the present embodiment, the two shielding curved plates 260A and 260B are provided as shown in FIG. 1 and rotate about the rotation axis L3 independently of each other. That is, the shielding curved plates 260A and 260B are present on the first sensor-side virtual cylindrical surface C1 corresponding to the rotation axis L3 (FIG. 3) that is another axis parallel to and near the axes L1 and L2 of the optical-system-side virtual cylindrical surfaces, are set so as to be independently rotatable about the rotation axis L3, and are locked at predetermined positions in the rotation direction. The rotation axis L3 of the first sensor-side virtual cylindrical surface C1 is parallel to the axis L1 or L2 of the optical-system-side virtual cylindrical surface, but may coincide with the axis L1 or L2.

The shielding curved plates 260A and 260B are each formed from a material having a low transmittance for the wavelength range of electromagnetic waves used as detection rays (far-infrared rays in the present embodiment), and, for example, is formed from a polycarbonate (PC) resin or the like. In addition, the shielding curved plates 260A and 260B are transparent in a view in the incoming direction of infrared rays. If the shielding curved plates 260A and 260B are not transparent, there is a possibility that the shielding curved plates 260A and 260B are viewed from the outside of the security sensor device 1 through the detection lens 120 and thus the shielding region is recognized. However, in the present embodiment, since the shielding curved plates 260A and 260B are transparent, such a possibility can be reduced.

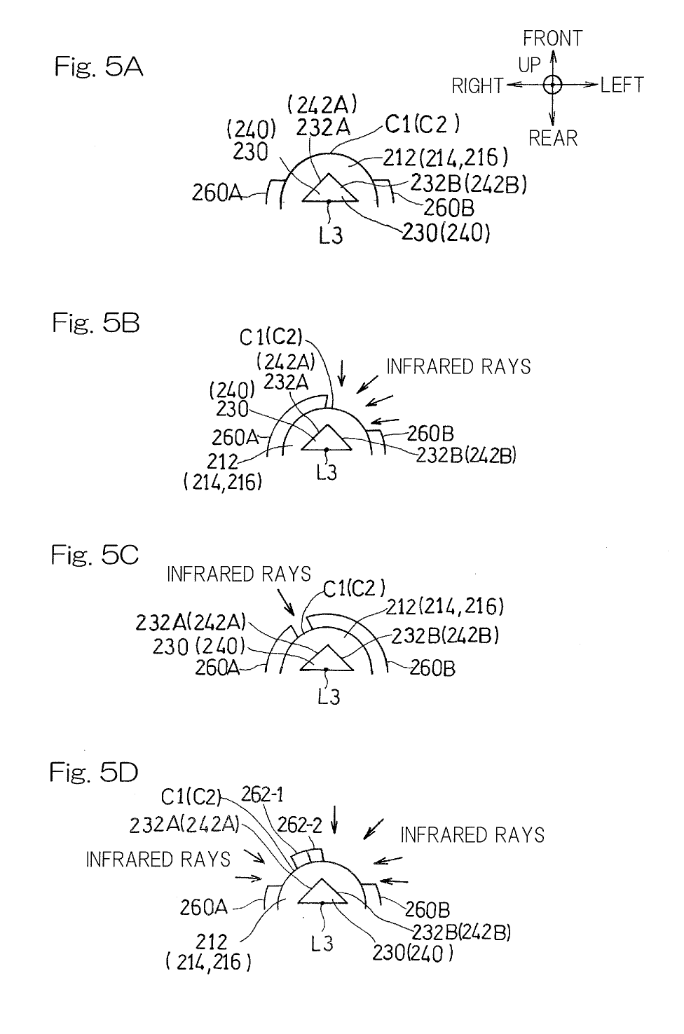

FIG. 5A shows the two shielding curved plates 260A and 260B, each of which is present on a part of the first sensor-side virtual cylindrical surface C1 and set so as to be rotatable about the rotation axis L3 as mentioned above. Here, the shielding curved plates 260A and 260B can be locked at predetermined positions (eight positions in the present embodiment), in the rotation direction, which correspond to directions in which infrared rays from the respective lens pieces 122-1 to 122-8 can be blocked. Thus, by performing simple work of manually rotating the shielding curved plates 260A and 260B and locking the shielding curved plates 260A and 260B at any of the eight predetermined positions, any of infrared rays corresponding to the respective lens pieces 122-1 to 122-8 can be blocked without masking (shielding) using a light-shielding sheet as in the conventional art.

As shown in FIG. 5B, for example, only the first shielding curved plate 260A is rotated and extended to the frontmost position of the security sensor device 1, and the second shielding curved plate 260B is locked at a predetermined position that is a rearmost position at the left side of the security sensor device 1. Accordingly, infrared rays coming to the security sensor device 1 from the front, the left front, and the left of the security sensor device 1 can reach the infrared ray detection elements 232B and 242B, and it can be made impossible for infrared rays from the other directions to reach any infrared ray detection element (specifically, the infrared ray detection elements 232A and 242A).

In addition, as shown in FIG. 5C, for example, the first shielding curved plate 260A is rotated and extended substantially to the right front position of the security sensor device 1, and the second shielding curved plate 260B is rotated and extended to the right side beyond the front of the security sensor device 1. Accordingly, only infrared rays coming to the security sensor device 1 from a very limited direction in the right front of the security sensor device 1 can reach the infrared ray detection elements 232A and 242A, and it can be made impossible for infrared rays from the other directions to reach any infrared ray detection element (specifically, mainly the infrared ray detection elements 232B and 242B). As described above, the shielding curved plates 260A and 260B can be locked at any position and can permit entry of infrared rays from any direction through the front face of the base unit 200 or block such infrared rays.

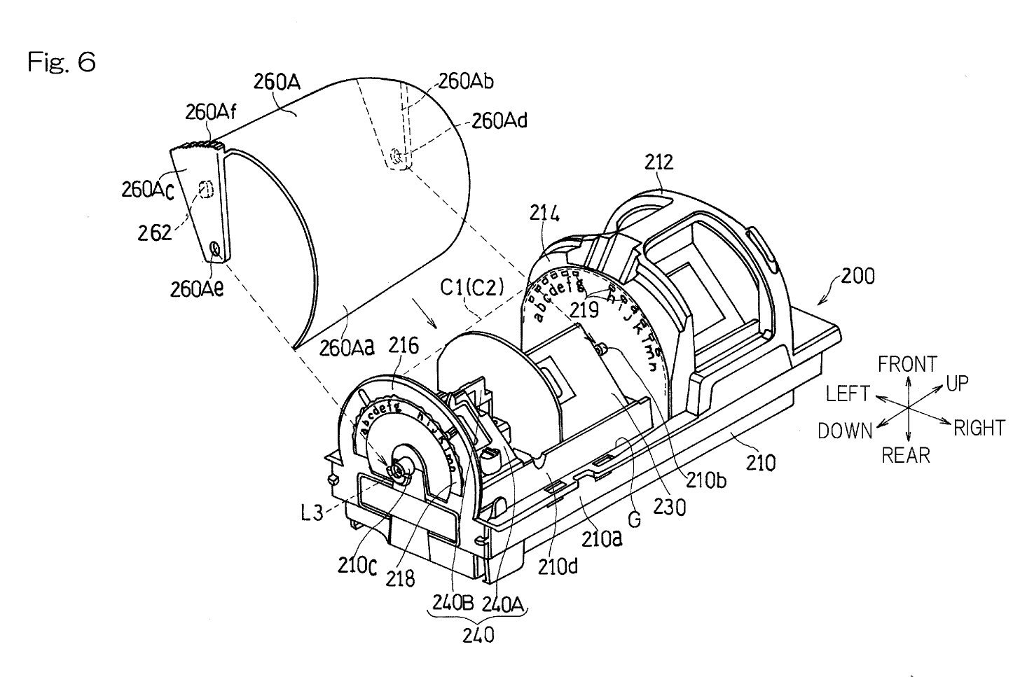

FIG. 6 is an exploded perspective view showing a main part of the security sensor device 1. With reference to FIG. 6, the shielding curved plates 260A and 260B are attached to the main body 210 of the base unit 200 so as to be rotatable about the rotation axis L3. The first shielding curved plate 260A and the second shielding curved plate 260B have shapes that are substantially bilaterally symmetrical to each other. Thus, in FIG. 6, only the first shielding curved plate 260A is shown, and the second shielding curved plate 260B is not shown.

Specifically, in the first shielding curved plate 260A of the present embodiment, a first arm 260Ab and a second arm 260Ac are provided at the upper end and the lower end of a partial-cylindrical curved plate body 260Aa, respectively, so as to extend radially inward. A knurled portion 260Af for preventing slip is formed only on the radially outer circumferential surface of the second arm 260Ac. Support holes 260Ad and 260Ae are formed in rotation center portions of the arms 260Ab and 260Ac, respectively. Support shafts 210b and 210c each having a circular column shape are provided at center portions of the flange portions 214 and 216, respectively, so as to project therefrom. The arms 260Ab and 260Ac are mounted to the support shafts 210b and 210c by fitting the support hole 260Ad to the support shaft 210b and fitting the support hole 260Ae to the support shaft 210c, and the first shielding curved plate 260A is rotatable about the rotation axis L3 relative to the flange portions 214 and 216. The second shielding curved plate 260B also has arm portions corresponding to the arms 260Ab and 260Ac. By mounting the arm portions to the support shafts 210b and 210c, the second shielding curved plate 260B is attached so as to be rotatable about the rotation axis L3 relative to the flange portions 214 and 216 independently of the first shielding curved plate 260A.

Meanwhile, a locking portion 218 for locking the shielding curved plates 260A and 260B at predetermined positions in the rotation direction with a click feeling is formed on one or each of the flange portions 214 and 216. In addition, a support base 210d for supporting the first detection element portion 230 and the second detection element portion 240 is provided to the main body 210 of the base unit 200. Parts of the first shielding curved plate 260A and the second shielding curved plate 260B enter a gap G between a side wall 210a of the main body 210 and the support base 210d. When the entire shielding curved plates 260A and 260B are inserted into the gap G, since the lengths of the arms 260Ab and 260Ac are equal to those of the above arm portions, if the curvatures of both shielding curved plates are equal to each other, the shielding curved plates 260A and 260B may collide with each other in the gap G. Thus, the shielding curved plates 260A and 260B have end portions that face the gap G and that respectively have a tapered shape or a reversely tapered shape corresponding to the tapered shape. Accordingly, when the entire shielding curved plates 260A and 260B are inserted into the gap G, the shielding curved plates 260A and 260B make motion of crossing each other along the respective tapered shape and reversely tapered shape.

In the present embodiment, a locking portion 218 composed of a substantially arc-shaped groove centered at the rotation axis L3 is formed only on the lower surface of the flange portion 216. Specifically, the locking portion 218 has, at a plurality of locations on the outer arc thereof, semicircular recesses facing in the radially outward direction of the arc. The first shielding curved plate 260A that rotates as described above is locked to the main body 210 with a click feeling by engaging a projection-like engagement piece 262 of the first shielding curved plate 260A shown in FIG. 6 with any one of the recesses of the locking portion 218. The semicircular recesses are provided at 14 locations with position-indicating marks composed of characters “a” to “n” as in the example of FIG. 6.

The shielding curved plates 260A and 260B of the present embodiment are present on the first sensor-side virtual cylindrical surface C1, are set so as to be rotatable about the rotation axis L3 as described above, and are locked at predetermined positions in the rotation direction to block infrared rays coming to the infrared ray detection elements 232A, 232B, 242A, and 242B. Therefore, it is not necessary to perform masking using a light-shielding sheet as in the conventional art, and it is possible to flexibly handle setting of the detection direction by performing simple work of rotating the shielding curved plates 260A and 260B, which have a low infrared ray transmittance, and locking the shielding curved plates 260A and 260B at the predetermined positions. In the structure having the shielding curved plates 260A and 260B, the effect of being able to flexibly handle setting of the detection direction can be further exerted in the case where the infrared ray detection elements 232A, 232B, 242A, and 242B have a fixing structure for not making a rotation motion about the axis of the optical-system-side virtual cylindrical surface relative to the base unit 200 as in the present embodiment.

The security sensor device 1 of the present embodiment has the signal processing unit 280 as an electrical system circuit for infrared ray detection as shown in a block diagram in FIG. 9. Each of output signals from the infrared ray detection elements 232A and 242A is inputted into a first arithmetic section 282, and each of output signals from the infrared ray detection elements 232B and 242B is inputted into a second arithmetic section 284. In the first arithmetic section 282, detection of infrared rays is performed using one or both of the output signals from the infrared ray detection elements 232A and 242A. For example, in the present embodiment, in the first arithmetic section 282, infrared ray detection with improved detection accuracy is performed using the output signal from the infrared ray detection element 232A and the output signal from the infrared ray detection element 242A having the substantially same detection center direction as that of the infrared ray detection element 232A and having a detection distance different from that of the infrared ray detection element 232A. Also in the second arithmetic section 284, detection is performed in a manner similar to that in the first arithmetic section 282, and the description thereof is omitted. A third arithmetic section 286 outputs a detection signal that is an infrared ray detection result as a whole, by using the operation results of the first arithmetic section 282 and the second arithmetic section 284. An output signal from a sensor 250 such as a microwave sensor may be inputted into the third arithmetic section 286.

In the present embodiment, in the case where the infrared ray detection elements 232A and 242A and the infrared ray detection elements 232B and 242B are configured such that two detection regions thereof overlap in the horizontal direction, the third arithmetic section 286 performs an AND operation of the detection result of the first arithmetic section 282 and the operation result of the second arithmetic section 284 so as to perform an operation for compensating for accuracy decrease due to disturbance noise, and outputs a detection signal. For example, output of a warning or the like from an alarm is performed using this detection signal, whereby a notification of appearance of an intruder is sent.

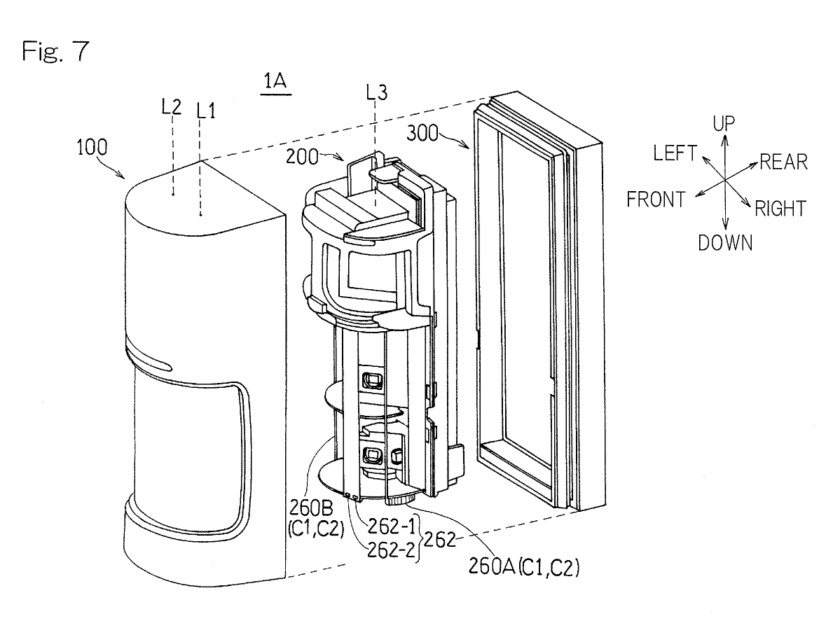

Next, a security sensor device according to a second embodiment of the present invention will be described. The contents other than the following description are the same as in the first embodiment, and the redundant description is omitted. As shown in FIG. 7, the security sensor device 1A of the present embodiment also includes a long-length light-shielding member 262 (two light-shielding members 262-1 and 262-2 in FIG. 7) in addition to the shielding curved plates 260A and 260B. The light-shielding member 262 is provided so as to be aligned on a second sensor-side virtual cylindrical surface C2 corresponding to the rotation axis L3, extends parallel to the rotation axis L3, and partially blocks infrared rays coming to the infrared ray detection elements. In the present embodiment, the second sensor-side virtual cylindrical surface C2 coincides with the first sensor-side virtual cylindrical surface C1 (FIGS. 5A to 5D). In this case, the first sensor-side virtual cylindrical surface C1 and the second sensor-side virtual cylindrical surface C2 are concentric with each other and have the same size, that is, are present on the same cylindrical surface, and the detection elements are disposed so as to be offset from the rotation axis L3 toward the cylindrical surface side, that is, radially outward, with respect to each of the right half (first sensor-side virtual cylindrical surface C1) and the left half (second sensor-side virtual cylindrical surface C2) thereof.

The light-shielding member 262 can be provided so as to extend on and between the flange portions 214 and 216 by diverting or using for the light-shielding member 262, one of 14 engagement holes 219 corresponding to position-indicating marks “a” to “n” provided on the flange portion 214 shown in FIG. 6 and one of the recesses of the locking portion 218 formed on the flange portion 216. Accordingly, the light-shielding member 262 can be provided at a predetermined position in the rotation direction corresponding to the direction of any of infrared rays from the respective lens pieces 122-1 to 122-8 that is desired to be blocked. The respective position-indicating marks “a” to “n” on the flange portions 214 and 216 correspond to the directions in which infrared rays come from the respective lens pieces 122-1 to 122-8.

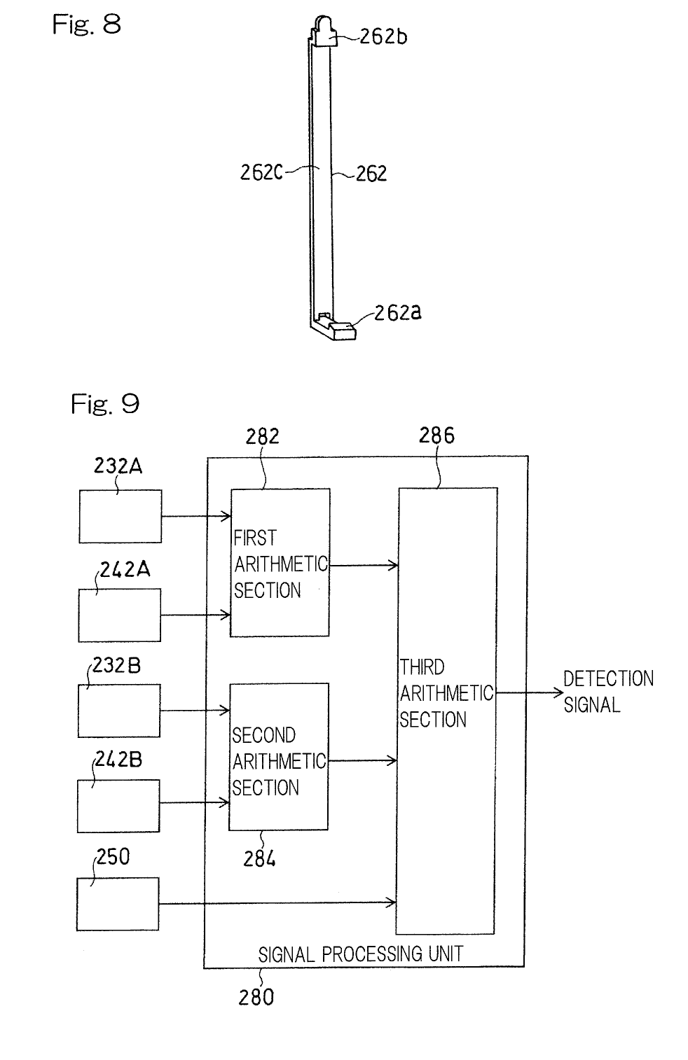

Specifically, as shown in FIG. 8, the light-shielding member 262 has: a held portion 262a provided at one end of a light-shielding main body 262c and having a claw-like structure; and an engagement projection 262b provided at the other end of the light-shielding main body 262c. The held portion 262a is held by fitting the claw-like structure to the semicircular recess of the locking portion 218 on the flange portion 216 in FIG. 6. The engagement projection 262b is engaged with the engagement hole 219 of the flange portion 214 corresponding to the recess to which the held portion 262a is fitted. The engagement holes 219 are arranged on a semicircle centered at the rotation axis L3. Accordingly, the position of the light-shielding member 262 in the circumferential direction about the rotation axis L3 is determined.

The light-shielding member 262 is formed from a material having a low transmittance for the wavelength range of electromagnetic waves used as detection rays (far-infrared rays in the present embodiment), and, for example, is formed from a PC resin or the like. In addition, the light-shielding member 262 is transparent in a view in the incoming direction of infrared rays. If the light-shielding member 262 is not transparent, there is a possibility that the light-shielding member 262 is viewed from the outside of the security sensor device 1 through the detection lens 120 and thus the shielding region is recognized. However, in the present embodiment, since the light-shielding member 262 is transparent, such a possibility can be reduced.

FIG. 5D shows an example of arrangement of the light-shielding member 262. For example, the first shielding curved plate 260A is locked at a predetermined position that is a rearmost position at the right side of the security sensor device 1A, and the second shielding curved plate 260B is locked at a predetermined position that is a rearmost position at the left side of the security sensor device 1A. Furthermore, the two light-shielding members 262-1 and 262-2 are provided at a position in the rotation direction that is not covered by the shielding curved plates 260A and 260B, for example, at a predetermined position in the right front of the security sensor device 1A. Accordingly, it is made locally impossible for infrared rays coming to the security sensor device 1A from the right front to reach any infrared ray detection element (specifically, the infrared ray detection elements 232A and 242A), and infrared rays from the other directions can reach the infrared ray detection elements 232A, 232B, 242A, and 242B.

By using the light-shielding member 262 of the present embodiment, the direction in which infrared ray detection is blocked can be locally and additionally set in addition to the shielding curved plates 260A and 260B. Moreover, the light-shielding member 262 is attached at the base unit 200 side at which the infrared ray detection elements 232A, 232B, 242A, and 242B are present, not at the cover unit 100 side at which the detection lens 120 is present. Thus, attaching work of attaching a light-shielding sheet for masking while viewing the detection lens 120 from the inner side as in the conventional art is not required. Accordingly, a wrong operation during attachment of the light-shielding sheet is prevented, and time and effort for the attaching work are omitted.

Although the present invention has been fully described in connection with the preferred embodiments thereof with reference to the accompanying drawings which are used only for the purpose of illustration, those skilled in the art will readily conceive numerous changes and modifications within the framework of obviousness upon the reading of the specification herein presented of the present invention. Accordingly, such changes and modifications are, unless they depart from the scope of the present invention as delivered from the claims annexed hereto, to be construed as included therein. For example, the following configurations can be included therein.

The security sensor device 1 can be similarly used for an AIR device that uses near-infrared rays as detection rays, has a light-projecting element and a light-receiving element in a base unit, emits near-infrared rays from the light-projecting element through a light-projection-side optical system disposed in a cover unit to the outside of the sensor device, and concentrates near-infrared rays, which has collided against and reflected from a detection object, onto the light-receiving element by a light-reception-side optical system disposed in the cover unit, thereby detecting the detection object. Moreover, in addition to the Fresnel lens, another optical member such as a prism may be used as an optical member. The optical-system-side virtual cylindrical surfaces Cs1 and Cs2, that is, the Fresnel lenses 120A and 120B, or the detection lens 120 including the Fresnel lenses 120A and 120B, may have an elliptic cylindrical shape or a polygonal cylindrical shape other than the circular cylindrical shape. Furthermore, the infrared ray detection elements 232A, 232B, 242A, and 242B of each embodiment described above have a fixing structure for not making a rotation motion about the axis of the optical-system-side virtual cylindrical surface relative to the base unit 200, but may make a rotation motion about the axis of the optical-system-side virtual cylindrical surface relative to the base unit 200 without having such a fixing structure. In such cases as well, the same advantageous effects as in each embodiment described above are achieved.

### REFERENCE NUMERALS

1, 1A . . . security sensor device
100 . . . cover unit
120 . . . detection lens (detection optical system)
120A, 120B . . . Fresnel lens (optical member group)
120C . . . connection portion
122-1 to 122-8 lens piece (optical member, Fresnel lens piece)
200 . . . base unit
232A, 232B . . . infrared ray detection element (far-infrared ray detection element)
242A, 242B . . . infrared ray detection element (far-infrared ray detection element)
260A, 260B . . . shielding curved plate
262, 262-1, 262-2 . . . light-shielding member
280 . . . signal processing unit
C1 . . . first sensor-side virtual cylindrical surface
C2 . . . second sensor-side virtual cylindrical surface
L1, L2 . . . axis of optical-system-side virtual cylindrical surface
L3 . . . rotation axis

What is claimed is:

1. A security sensor device comprising: a base unit having a detection element for detecting detection rays; and a cover unit covering a front face of the base unit, wherein
the cover unit has a plurality of optical members present so as to be aligned about a predetermined axis,
the base unit has the detection element disposed at a light-concentrated position onto which the detection rays from the plurality of optical members are concentrated,
the base unit further has a shielding curved plate housed in the cover unit, and
the shielding curved plate is set so as to be rotatable about the predetermined axis, and is locked at a predetermined position in a rotation direction to block the detection rays coming to the detection element.

2. The security sensor device as claimed in claim 1, wherein two plates rotatable independently of each other are present as the shielding curved plate.

3. The security sensor device as claimed in claim 1, further comprising a long-length light-shielding member provided so as to be aligned about the predetermined axis and parallel to the predetermined axis and blocking the detection rays coming to the detection element.

4. The security sensor device as claimed in claim 1, further comprising two or more far-infrared ray detection elements each having a field of view of about 90 degrees, wherein
the two or more far-infrared ray detection elements are arranged such that a total field of view thereof is about 180 degrees.

5. The security sensor device as claimed in claim 1, wherein the shielding curved plate is transparent in a view in an incoming direction of the detection rays.

6. The security sensor device as claimed in claim 3, wherein the light-shielding member is transparent in a view in an incoming direction of the detection rays.
